(19) United States
(12) Patent Application Publication
(10) Pub. No.: US 2023/0167603 A1
(43) Pub. Date: Jun. 1, 2023

(54) METHOD FOR THE PRODUCTION OF PAPER PRODUCTS

(71) Applicant: NOVATRUST SA, Lugano (CH)

(72) Inventor: Simone PRIANTE, Rovlo (CH)

(21) Appl. No.: 17/998,088

(22) PCT Filed: Apr. 15, 2021
(86) PCT No.: PCT/EP2021/059750

§ 371 Date: Nov. 7, 2022

(30) Foreign Application Priority Data
May 15, 2020 (CH) 00590/20
May 15, 2020 (IT) 102020000011149

(51) Int. Cl. D21C 5/02; D21H 17/28; D21H 17/65

(52) U.S. Cl. CPC D21C 5/022; D21H 17/28; D21H 17/65

(57) ABSTRACT

A method for the production of paper products, such as paper and cardboard, by recycling cellulose-based raw materials containing starch. The method includes the steps of pulping in water cellulose-based raw materials containing starch, particularly recycled paper products, obtaining a pulped mass; adding to the pulped mass of the previous step under agitation a mineral acid in a quantity that is suitable to obtain a pH of the pulped mass not lower than 4, and obtaining a pulped mass treated with acid. The method further includes the step of subjecting the pulped mass treated with acid obtained in the second step, optionally treated with other chemical additives, in succession, to filtration, pressing and drying, and obtaining a paper product. Paper products obtainable by this method are also related.

### TECHNICAL FIELD

The present disclosure relates to a method for the production of paper products, such as paper and cardboard, by recycling cellulose-based raw materials containing starch.

### BACKGROUND

Traditionally, paper products are obtained starting from wood from which the bark is removed by means of drum grinding wheels; the debarked wood is then comminuted into very small fragments, which are then conveyed into a cylindrical boiler inside which the wood is mixed with caustic soda at approximately 170° C. As an alternative, however, the debarked logs can also be simply shredded in a mechanical defibering machine in order to produce wood pulp. The results of these operations are bleached, further shredded and merged in a conical refiner.

Currently, during this step, variable percentages of products obtained from paper recycling are added and are pulped by means of a rotary blade hydropulper. Waste paper can be introduced in more or less high percentages depending on the desired end product and in some cases can constitute 100% of the paper pulp.

All the refined pulp, deprived of the impurities, is passed through vats or mixing systems, in which other substances are added in relation to the type of paper that one wishes to obtain. These are fillers, such as gypsum, talc and kaolin, which render the sheet whiter and easily printable; a coloring coat, which makes the paper assume the desired color; the glue, which is used to better assemble the fibers and render the sheet writable or printable; other chemical additives, such as polymers, biocidal products, microparticles, dispersants, each with a specific aim suitable to improve the efficiency of the technological process for the production of paper. In particular, the mixture receives the addition of a more or less high proportional quantity of starch and/or glue, depending on the strength and impermeability that one wishes to give to the finished sheet, and in the case of many graphic papers which start from pure cellulose, an inert filler, generally calcium carbonate obtained from residues of the processing of marble or directly from quarries, in order to improve the color, increase its weight (grammage) and reduce its final cost. For example, for the production of high-value mat and glossy paper without wood, up to 40 kg of starch per ton of finished product are used. The process for the production of packaging paper from 100% recycled paper can require the addition of even up to 15% by weight of starch (native or modified) with respect to the total weight of the recycled paper in order to improve the final mechanical strength characteristics of the finished sheet.

Mixed in this way, the pulp finally arrives to the head box of the continuous flatbed machine. From the head box, the pulp is made to drip onto a thin perforated belt which moves at high speed, while an extractor extracts most of the water; the pulp consolidates into a thin layer, which is pressed by means of the action of compression rollers and dried with steam-heated drying rollers. The process is continuous, since one obtains a continuous ribbon of paper which is finally rolled up in large rolls, cut and/or stacked in sheets.

Paper is therefore substantially a thin film of cellulose and bonding agents, mostly starches.

Starch is a polysaccharide and has always been used as an aid for the production of paper owing to its properties as retention agent for filtration, since it reduces the quantities of solids suspended in the water filtered by the fabric of the continuous machine, and for the improvement of the mechanical characteristics of the finished sheet, in particular in order to obtain stronger paper.

Recycled cardboard, used mainly in paper mills that manufacture packaging paper, contains a high quantity of starch. The starch remains partly dissolved during the entire process for the preparation of the pulped mass, but it also undergoes an organic degradation process which reduces its beneficial qualities.

For this reason there are methods which tend to preserve its qualities during the steps of the process. These technologies are based on the principle of reducing the bacterial activity that degrades the starch in solution in the pulped mass, using it as a source of nutrient.

These technologies can be traced mainly to:
use of biocidal agents, chemical substances for reducing the bacterial activity that degrades the starch in solution;
use of fixing agents, chemical substances which tend to fix the starch in solution to the fiber;
management of the process cycle so as to reduce the processing time of the mixture and therefore the degradation of the starch.

The effectiveness of the methods described above which seek to preserve from degradation the modest quantities of solubilized starch depends on many process parameters, with the result that significant variability is observed in the quantity of starch available in solution during and after the pulping step.

The available quantity of starch in solution obviously depends on the quality and the quantity of the raw material used, but even if they are the same, a variability of the quantity of starch naturally dissolved and present in the process for the preparation of the mixture is in any case observed both within the same production site and in different production sites. It seems in fact that by following the approaches used so far, aimed exclusively at preserving the starch from degradation, the starch contained in the recycled paper is available in the process only in a small fraction.

### SUMMARY

In view of the limitations of the background art described above, the aim of the present disclosure is to provide an improved method for the production of paper products that allows to maximize the quantity of starch obtained from recycled raw material.

The present disclosure provides a method that allows to obtain paper with high mechanical characteristics of the finished sheet, in particular increased strength.

The present disclosure provides a method that is more convenient from an economic and environmental standpoint and allows to minimize or avoid the addition of glues or of fresh starch.

Finally, the present disclosure provides a finished product with high mechanical properties by means of a method that is more convenient from an economic and environmental standpoint.

This aim and these and other advantages are achieved by providing the method according to the present disclosure.

### DETAILED DESCRIPTION OF THE DISCLOSURE

In a first aspect, the present disclosure provides a method for the production of paper products, such as paper and cardboard, comprising the steps of:

i) pulping in water cellulose-based raw materials containing starch, particularly recycled paper products, obtaining a pulped mass;

ii) adding to the pulped mass of step i) under agitation a mineral acid in a quantity that is suitable to obtain a pH of the pulped mass not lower than 4, preferably a pH comprised between 4 and 9, obtaining a pulped mass treated with acid;

iii) subjecting the pulped mass treated with acid obtained in step ii), optionally treated with other chemical additives, in succession, to filtration, pressing and drying, obtaining a paper product.

The process is compatible with all kinds of recycled raw materials based on cellulose, such as papers, cardboards, thin cardboards, fibrous trims with or without wood, white blank news, fibrous ribbed and flimsy.

The addition of acid is preferably performed gradually, controlling the pH continuously, avoiding dropping below pH 4. The gradual addition of the acid facilitates the extraction of the starch, which in turn buffers the system. As long as the starch extraction process proceeds after each addition of acid the pH exhibits a trend to rise towards the initial pH; accordingly, the absence or decrease of this pH rebalancing process indicates that the available starch has been extracted. The addition of acid is performed gradually, monitoring the pH, so as to maximize the extracted quantity of starch and shift as little as possible from the initial pH of the system. The addition of an excessive quantity of acid with respect to what is necessary in order to solubilize the starch that is present in the paper materials might in fact partially solubilize inorganic components such as calcium carbonate, increasing the quantity of interfering agents in the mixture and compromising the inter-fiber bonds. The pH monitoring as described above instead allows to add to the quantity of acid that is necessary to solubilize effectively the starch that is present.

The starch forms bonds with the negative sites that are present on the cardboard fibers. When it is immersed in a water-based solution, the latter, by virtue of its amphoteric nature, acts as a solvent:

2H₂O⇔H₃O⁺+OH⁻

The H₃O⁺ molecules “detach” the starch that is present on the cardboard, acting as true competitors on the fiber-starch bond as in the principle of ion exchange resins. On the basis of this, without intending to be bound to a particular theory, one can hypothesize that the availability of dissolved starch may be increased by virtue of a high concentration of H₃O⁺ ions that derive from an acid species.

It has been observed that the addition of a mineral acid to the pulped mass surprisingly improves the availability of starch in the pulped mass, with a significant improvement of the mechanical characteristics of the finished product (as shown in Example 2).

In one embodiment, the quantity of mineral acid added in step ii) is comprised between 0.1% and 10%, preferably between 1% and 2% by weight on the total weight of the cellulose-based raw materials.

In one preferred embodiment, the mineral acid is selected from the group consisting of sulfuric acid (H₂SO₄) at a concentration comprised between 20% and 98% by weight, preferably 79% by weight, hydrochloric acid (HCl) at a concentration comprised between 10% and 37% by weight, preferably 37% by weight, and phosphoric acid (H₃PO₄) at a concentration comprised between 20% and 85% by weight, preferably 75% by weight.

Among the strong acids that can be used in the process according to the disclosure, the use of sulfuric acid is particularly advantageous, since it has a lower cost than phosphoric acid and acts preferably on the organic material that is present in the pulped mass; furthermore, at the concentration of use it is a strong oxidizer and as such has a synergistic action with the biocidal agents used in the paper production process.

When hydrochloric acid is used, one must take into account that it has ash removal properties which might compromise the quality of the finished product. Hydrochloric acid in fact can solubilize the calcium carbonate used as mineral filler in the paper production process. An excessive solubilization of the calcium carbonate can lead to such a calcium ion concentration as to interfere in the inter-fiber bonds and compromise the action of other chemical additives commonly used in the process.

When phosphoric acid is used, one must take into account that it has nutrient properties for some bacterial strains, and this might turn out to be disadvantageous in industrial processes in which one wishes to minimize the bacterial load in order to preserve as much as possible the starch released as a consequence of chemical extraction.

In one particularly preferred embodiment, the mineral acid is 79% by weight sulfuric acid.

Advantageously, the improved solubilization of the starch contained in the recycled paper materials allows to reduce or eliminate the need to add further starch in the paper production process.

In a preferred embodiment, the method according to the disclosure does not include the addition of starch.

In another preferred embodiment, the method according to the disclosure comprises, after step ii), the step of adding starch, in particular in a quantity that does not exceed 10% by weight on the weight of the cellulose-based raw materials.

Commonly used paper production processes provide for the addition of starch in percentages that can vary from 1% up to in some cases 15% by weight on the weight of the cellulose-based raw materials as a function of the mechanical characteristics of the product that one wishes to obtain. The inventors of the present disclosure have surprisingly found that the method according to the disclosure allows to obtain paper with the same mechanical properties without the need to add starch or with additions of starch in quantities 30-50% lower than a process which, differently from the process according to the disclosure, does not comprise the addition of acid, and in any case not exceeding 10% by weight on the weight of the cellulose-based raw materials, depending on the initial raw material and on the properties sought in the finished product.

In one preferred embodiment, the method according to the disclosure furthermore comprises a step for the removal, reduction or control of the ink that is present in the initial cellulose-based raw materials.

The ink removal process in paper mills is mainly performed by the principle of flotation, which is a physical interaction between air bubbles that are introduced and ink particles that are present in the aqueous dispersion of the mixture.

Generally, in flotation one introduces, with specific methods, air which is dispersed in bubbles within the mixture, in order to obtain a grouping of the ink particles in the air-water interface of the individual formed bubbles.

The size of the bubbles is fundamental for the success of the operation, and so is the fact that the ink particles must be hydrophobic, so as to remain predominantly on the surface of the bubble, and this occurs indeed because since they are hydrophobic they tend to refuse contact with water.

The surface foam that forms as a consequence of what has been described above contains the ink particles and is eliminated by overflow.

In a preferred embodiment, the method according to the disclosure furthermore comprises a step for the removal, reduction or control of impurities such as resins, paraffins, pitches and glues.

The resins and paraffins in fact constitute a problem, since they prevent the fixing of the ink. The presence of pitches and glues “(so-called “stickies”) causes problems during the production process, leading to defects of an aesthetic and mechanical nature in the finished product.

The removal, reduction or control of these impurities occurs with methods that mainly use the physical properties that they prove to have within the fibrous mixture.

The mechanical methods make use of physical properties such as for example relative density, the degree of pulpability (difference in the aptness to be dispersed in fibrous water-based dispersions) and the degree of wettability.

These methods comprise, for example, filtration, centrifuging, decantation and dispersion understood as a reduction to smaller particles.

However, there are other methods which make use of chemical/physical properties such as for example cationic demand, zeta potential, solubility, reactivity to dispersants and/or solvents, stability, the reduction or increase of dimensions by aggregation or by chemical reaction.

These methods tend to introduce in the mixture, by virtue of appropriate dosage systems, compounds or substances which modify in a more or less significant manner the properties discussed above.

In a preferred embodiment, the method according to the disclosure furthermore comprises the step of adding, after step ii), one or more chemical additives selected from the group consisting of inert fillers, additives for improving retention, additives for improving draining, additives for improving fixing, additives with a biocidal action, polymers, microparticles, dispersants and additives with an anti-foaming action.

As in fact known to the person skilled in the art, the addition of fillers and/or retention agents and/or fixing agents and/or draining agents, with disparate combinations of dosages and dosage systems, can improve and/or modify the behavior of the fibrous mixture in the various steps of the process.

These agents, are, for example, as regards inert fillers, kaolins, calcium carbonates, titanium dioxides, bentonites and silicas, whereas as regards retention and/or fixing and/or draining agents it is possible to use for example coagulants, aluminum polychlorides, polyamines, dispersants, anti-foaming agents, polyacrylamides, cationic polymers, anionic polymers, or neutral polymers.

In another aspect, the disclosure relates to a paper product that can be obtained by means of the method according to the disclosure.

In particular, the method according to the disclosure allows to produce new paper types that would have been too expensive to produce with current processes. The methods currently used to increase paper strength in fact entail the addition of expensive additives such as starch or polymeric resins. Advantageously, the method according to the disclosure allows to maximize the reuse of the starch contained in the initial materials and therefore reduces the need to add to the process additional fresh starch or synthetic chemical agents.

Since starch is a retention agent, the greater availability in the paper pulp contributes to the activity of polymers, microparticles and coagulants, allowing to produce a recycled cardboard with better mechanical strength, minimizing the addition of fresh starch.

Furthermore, it has been observed that the method according to the disclosure allows to obtain a finished product, and in particular recycled cardboard, with better mechanical strength than the product obtained with the traditional process without the addition of fresh starch.

Preliminary bursting data (Edge Compression Test) show, for paper produced with the method according to the disclosure in absence of an addition of starch, an average increase of 33-35% with peaks up to 52-55% (35% in Example 5, Table 2) with respect to paper obtained starting from the same initial materials with the traditional method which does not provide for the addition of sulfuric acid.

Furthermore, the finished product has a reduction in defects such as for example so-called “oil stains” caused by resins and paraffins, thanks to a better dissolution of the main organic and inorganic contaminants.

The method according to the disclosure also entails a reduction in the forming of foam, with a consequent advantage in the management of the continuous machine and optimization of the management of the wastewater treatment system.

Another advantage of the method according to the disclosure is a reduction of odor, with a benefit for the environment and for the workplace.

The method according to the disclosure allows effective recycling of inexpensive paper materials which are currently considered problematic, such as so-called converting, which is contaminated by glues which risk causing problems in the papermaking processes currently in use, or so-called broke and other paper processing waste.

Effective reuse of starch allows a saving on expensive reagents which are normally added to the pulped mass in commonly used processes, such as native and cationic starch, glues and polymeric resins. Furthermore, the biocidal/bacteriostatic action of the acid allows to reduce the use of biocidal agents with significant economic benefit, a benefit to the environment and to the workplace. The method according to the disclosure also allows to reduce the use of solvents or dispersants.

In practice it has been found that the method according to the disclosure fully achieves the intended aim, since it allows to maximize the reuse of the starch that is present in the initial materials in the process for the production of paper products, thus allowing to eliminate or reduce the need to add fresh starch and other retention agents, with a consequent improvement of the process from an economic and environmental standpoint. Also, thanks to the method according to the disclosure it is possible to increase the continuity of the process and limit the maintenance of the systems, which tend to become less contaminated.

The disclosure thus conceived is susceptible of numerous modifications and variations, all of which are within the scope of the inventive concept; all the details may furthermore be replaced with other technically equivalent elements.

The disclosure is now described further with reference to the following nonlimiting examples.

### Example 1: Solubilization of Starch in Water

Under agitation, 100 mL of water and respectively 4 g and 8 g of recycled paper, shredded manually by using scissors until fragments with a size of approximately 5 mm were obtained, were added in two beakers. In order to obtain a qualitative and quantitative determination of the starch solubilized in water in the two beakers, the beakers received the addition, under agitation, for 10 minutes at 120 rpm, of the same quantity (3 drops) of a solution of 5% Lugol (mixture composed of 85% distilled water, 10% potassium iodide, and 5% iodine). In order to quantify the starch that is present in the various samples, a spectrophotometric method was used. The absorbance of the samples was measured by means of a Hach DR3800 spectrophotometer at a wavelength equal to 620 nm.

The measurements taken correspond respectively to 0.08% by weight of starch on the total weight of the paper in the first beaker and 0.15% by weight of starch on the total weight of the paper in the second one.

The data demonstrate the solubilizing action of the water with respect to the starch contained in the paper, which is proportional in solution to the quantity of paper added to the respective beaker.

### Example 2: Solubilization of Starch in Water with the Addition of Sulfuric Acid

Under agitation, 100 mL of water and 4 g of recycled paper, shredded manually until fragments with a size of approximately 5 mm were obtained, were added in two beakers and the suspension was kept under agitation for 10 minutes at 120 rpm. The second beaker then received the gradual addition (drop by drop), under agitation for 10 minutes at 120 rpm, of 0.2 mL of 79% sulfuric acid by weight. In order to obtain a qualitative and quantitative determination of the starch solubilized in water in the two beakers, the same quantity (3 drops) of 5% Lugol solution was added to the two beakers under agitation for 10 minutes at 120 rpm. A spectrophotometric method was used to quantify the starch present in the various samples. The absorbance of the samples was measured by means of a Hach DR3800 spectrophotometer at a wavelength equal to 620 nm.

The measurements taken correspond respectively to 0.08% starch on the total weight of the dry paper in the first beaker and 7.8% starch on the total weight of the dry paper in the second beaker.

The data demonstrate the increase in the solubilization of the starch contained in the paper due to the addition of the sulfuric acid to the suspension.

### Example 3: Solubilization of Starch in Water Pre-Acidified with Sulfuric Acid

Under agitation, 100 mL of water and 4 g of recycled paper, shredded manually until fragments with a size of approximately 5 mm were obtained, were added in a first beaker and the suspension was kept under agitation for 10 minutes at 120 rpm. The second beaker received the addition, under agitation, of 100 mL of water pre-acidified with 0.2 mL of 79% sulfuric acid by weight and 4 g of recycled paper shredded manually until fragments with a size of approximately 5 mm were obtained, and the suspension was kept under agitation for 10 minutes at 120 rpm. In order to obtain a qualitative and quantitative determination of the starch solubilized in water in the two beakers, the two beakers received the addition, under agitation for 10 minutes at 120 rpm, of the same quantity (3 drops) of 5% Lugol solution. A spectrophotometric method was used to quantify the starch present in the various samples. The absorbance of the samples was measured by means of a Hach DR3800 spectrophotometer at a wavelength equal to 620 nm.

The measurements taken correspond respectively to 0.07% by weight of starch on the total weight of the paper in the first beaker and 2.5% by weight of starch on the total weight of the paper in the second beaker.

The data show an increase in the solubilization of the starch contained in the paper by the pre-acidified water, but to a smaller extent than observed in experiment 2, where the acid was added directly to the suspension.

Without intending to be bound to a particular theory, it can be hypothesized that this difference is due to the fact that in experiment 3 the addition of the acid directly lowers the pH, since the shredded paper is added after acidification; in example 2, instead, the acid added gradually initially performs an action of extraction of the starch of the paper that is already present in the suspension and only subsequently there is the acidifying effect.

### Example 4: Effect of the Addition of Various Mineral Acids in the Paper Production Process

Under agitation, 100 mL of water and 4 g of recycled paper, shredded manually until fragments with a size of approximately 5 mm were obtained, were added in four beakers. In the first beaker (control), no acid was added, while in the other three, respectively, the following were added in an amount of 2% by weight with respect to the dry paper: sulfuric acid at a concentration of 79% by weight (second beaker), hydrochloric acid as a concentration of 37% by weight (third beaker), and phosphoric acid at a concentration of 75% by weight (fourth beaker).

In order to obtain a qualitative and quantitative determination of the start released in each sample, the same quantity (3 drops) of 5% Lugol solution was added under agitation to the four beakers.

The first beaker became colored with a pale blue color, whereas more intense colors, which corresponded to greater free starch quantities, were observed in the other three beakers treated with the various acids.

A spectrophotometric method was used to quantify the starch that is present in the various samples. The absorbance of the samples was measured by means of a Hach DR3800 spectrophotometer at a wavelength equal to 620 nm.

The measurements taken correspond to the quantities of starch listed in Table 1, expressed as a percentage by weight on the total weight of the dry paper.

TABLE 1

| | |
|---|---|
| Beaker 1 | 0.15% |
| Beaker 2 | 14% |
| Beaker 3 | 12.2% |
| Beaker 4 | 12.9% |

The above cited quantitative assessment demonstrates that the addition of mineral acids to the pulped mass allows to increase the release of starch in the suspension.

### Example 5: Characterization of Paper Obtained by Means of the Method According to the Disclosure

Two pulpings were performed starting from the same initial thin cardboard, using a laboratory pulper (laboratory pulper of Enrico Toniolo S.r.l.), pulping for 20 minutes 40 g of recycled thin cardboard in 1 L of industrial water.

Four sheets with an average grammage of 60.6 grams per square meter were obtained, by means of a standard method on a sheet forming apparatus, from the first pulping (comparison), performed with industrial water in the absence of acid.

The same number of sheets with an average grammage of 61.6 grams per square meter were obtained, by means of the same standard method on a sheet forming apparatus, from the second pulping (disclosure), in which 0.5 mL of 79% sulfuric acid by weight were added.

The sheets were left for 24 hours at an ambient temperature of 20° C. and a humidity of 55%.

Strength tests were performed on the sheets conditioned as specified previously by means of certified instruments (L&W Autoline, ABB), and the results showed an average 35% increase in the bursting values measured according to the TAPPI T403om-97 method.

The bursting index, which is the result of the division of the bursting value measured as above by the grammage of the individual sheet, was found to have be increased on average by 32.8%.

The results of the two experiments are shown in Table 2.

TABLE 2

| | comparison | | invention | | |
|---|---|---|---|---|---|
| | | std. | | std. | Delta |
| | average | dev. | average | dev. | % |
| Grammage (g/m²) | 60.6 | 1.1 | 61.6 | 1.2 | 1.7% |
| Thickness (microns) | 117 | 2.8 | 118 | 2.7 | 0.9% |
| Specific volume | 1.93 | | 1.91 | | −1% |
| (dm³/kg) | | | | | |
| Ashes (525° C., %) | 7.7% | 0.9 | 7.6% | 0.82 | −1.3% |
| Gurley porosity (s) | 7.1 | 1.8 | 7 | 1.5 | −1.4% |
| Tensile strength (kN/m) | 2.19 | 0.33 | 2.28 | 0.29 | 4.1% |
| Tensile index (Nm/g) | 36.2 | | 37.0 | | 2.2% |
| Elongation (%) | 1.9% | 0.013 | 1.91% | 0.01 | 0.5% |
| Modulus of elasticity | 2.49 | 0.36 | 2.5 | 0.34 | 0.3% |
| (GPa) | | | | | |
| Bursting strength (kPa) | 157 | 15.6 | 212 | 15.8 | 35% |
| Bursting index (kPam²/g) | 2.59 | | 3.44 | | 32.8% |

In addition to the demonstrated increase in bursting strength, one can also observe a considerable improvement that is perceivable by hand of the rigidity of the sheets prepared according to the disclosure.

The method according to the disclosure allows to obtain a paper product that has an improved mechanical strength with a reduction or even lack of addition of “fresh” starch to the process by virtue of a more effective use of the starch that is already present in the initial material.

1. A method for the production of paper products, such as paper and cardboard, the method including the following steps:
i) pulping in water cellulose-based raw materials containing starch, particularly recycled paper products, obtaining a pulped mass,
ii) adding to the pulped mass of step i) under agitation a mineral acid in a quantity that is suitable to obtain a pH of the pulped mass not lower than 4, obtaining a pulped mass treated with acid, and
iii) subjecting the pulped mass treated with acid obtained in step ii), optionally treated with other chemical additives, in succession, to filtration, pressing and drying, obtaining a paper product.

2. The method according to claim 1, wherein the quantity of mineral acid added in step ii) is comprised between 0.1% and 10%, by weight on the total weight of the cellulose-based raw materials.

3. The method according to claim 1, wherein said mineral acid is selected from the group consisting of: sulfuric acid (H₂SO₄) at a concentration comprised between 20% and 98% by weight, hydrochloric acid (HCl) at a concentration comprised between 10% and 37% by weight, and phosphoric acid (H₃PO₄) at a concentration comprised between 20% and 85% by weight.

4. The method according to claim 1, wherein said mineral acid is sulfuric acid (H₂SO₄) at a concentration comprised between 20% and 98% by weight, preferably 79% by weight.

5. The method according to claim 1, wherein said method does not include the addition of starch.

6. The method according to claim 1, wherein said method comprises, after step ii), the step of adding starch, in particular in a quantity not greater than 10% by weight on the weight of the cellulose-based raw materials.

7. The method according to claim 1, wherein said method further comprises a step of removal, reduction, or control of the ink that is present in the initial cellulose-based raw materials.

8. The method according to claim 1, wherein said method further comprises a step for the removal, reduction, or control of impurities such as resins, paraffins, pitches, and glues.

9. The method according to claim 1, wherein said method further comprises the step of adding one or more chemical additives selected from the group consisting of: inert fillers, additives for improving retention, additives for improving draining, additives for improving fixing, additives with a biocidal action, polymers, microparticles, dispersants and additives with an anti-foaming action.

10. A paper product obtainable by the method according to claim 1.
